(19) United States
(12) Patent Application Publication
(10) Pub. No.: US 2026/0358602 A1
(43) Pub. Date: Nov. 12, 2026

(54) OPTICAL SYSTEM AND IMAGE PICKUP APPARATUS EQUIPPED WITH THE SAME

(71) Applicant: CANON KABUSHIKI KAISHA, Tokyo (JP)

(72) Inventor: MAYU OHHORI, Tochigi (JP)

(21) Appl. No.: 19/663,048

(22) Filed: Apr. 29, 2026

(30) Foreign Application Priority Data
May 9, 2025 (JP) 2025-078494

(51) Int. Cl. G02B 13/00; G02B 7/02

(52) U.S. Cl. CPC G02B 13/0045; G02B 7/025; G02B 13/006

(57) ABSTRACT

An optical system includes: a front lens unit that is fixed relative to an image plane during focusing; and a focus lens unit that is disposed adjacent to an image side of the front lens unit and that moves during focusing. A distance between adjacent lens units changes during focusing, and satisfies a predetermined condition.

### BACKGROUND

### Field of the Technology

The aspect of the embodiments relates to optical systems and image pickup apparatuses equipped with the same, and particularly, to an image pickup optical system suitable for use in, for example, a camera for a portable terminal including a smartphone, a digital still camera, or a video camera, and to an image pickup apparatus equipped with such an image pickup optical system.

### Description of the Related Art

In recent years, image pickup optical systems used in image pickup apparatuses, such as cameras for portable terminals including smartphones, digital still cameras, and video cameras, have been required to be compact while having high optical performance.

Japanese Patent Laid-Open No. 2013-225159 discloses a focusing method in which the entire optical system moves during focusing.

### SUMMARY

An optical system according to an aspect of the embodiments includes: a front lens unit that is fixed relative to an image plane during focusing; and a focus lens unit that is disposed adjacent to an image side of the front lens unit and that moves during focusing. A distance between adjacent lens units changes during focusing. The optical system includes an aspherical lens disposed at the image side relative to the front lens unit. At least one surface of the aspherical lens has an inflection point.

An optical system according to another aspect of the embodiments includes: a front lens unit that is fixed relative to an image plane during focusing; and a focus lens unit that is disposed adjacent to an image side of the front lens unit and that moves during focusing. A distance between adjacent lens units changes during focusing. The optical system includes an aspherical lens disposed at the image side relative to the front lens unit.

Features of the disclosure will become apparent from the following description of embodiments with reference to the attached drawings. The following description of embodiments is described by way of example.

### BRIEF DESCRIPTION OF THE DRAWINGS

FIG. 1 is a cross-sectional view of an optical system according to example 1.

FIG. 2A is an aberration diagram at infinity in the optical system according to example 1.

FIG. 2B is an aberration diagram at a close distance in the optical system according to example 1.

FIG. 3 is a cross-sectional view of an optical system according to example 2.

FIG. 4A is an aberration diagram at infinity in the optical system according to example 2.

FIG. 4B is an aberration diagram at a close distance in the optical system according to example 2.

FIG. 5 is a cross-sectional view of an optical system according to example 3.

FIG. 6A is an aberration diagram at infinity in the optical system according to example 3.

FIG. 6B is an aberration diagram at a close distance in the optical system according to example 3.

FIG. 7 schematically illustrates a relevant part of an image pickup apparatus to which the optical system according to each example is applied.

### DESCRIPTION OF THE EMBODIMENTS

Embodiments of the disclosure will be described in detail below with reference to the drawings. In the drawings, identical members will be given the same reference sign, and redundant descriptions will be omitted.

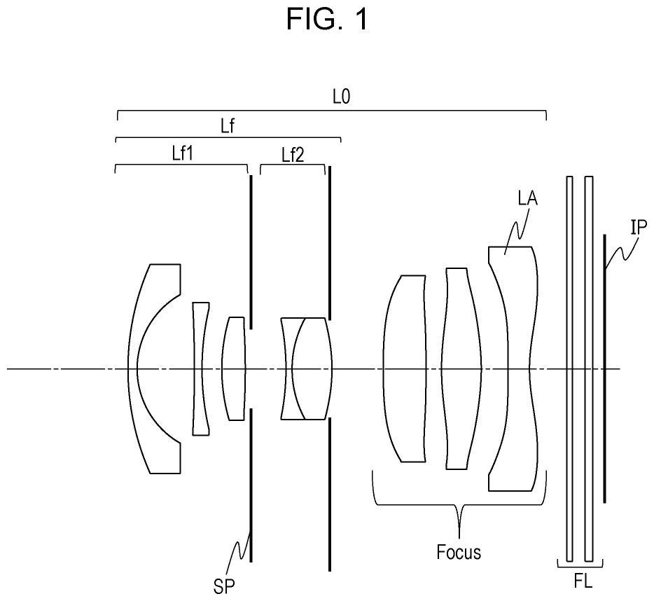

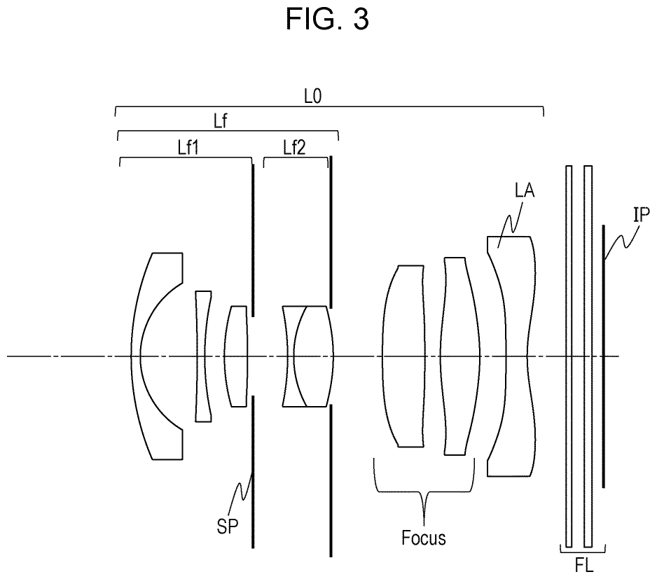

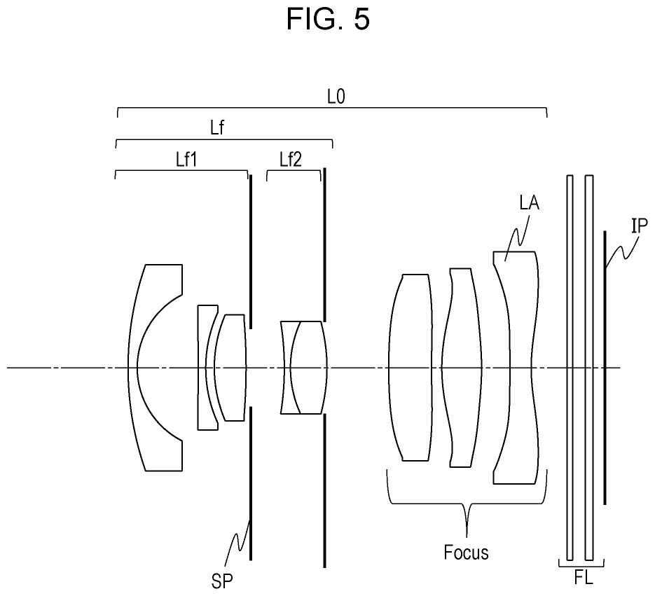

FIGS. 1, 3, and 5 are cross-sectional views of an optical system L0 according to examples 1 to 3, respectively. The optical system L0 according to each example is used in an image pickup apparatus, such as a digital still camera, a digital video camera, a surveillance camera, a vehicle-mounted camera, or a smartphone.

In each cross-sectional view, the left side is an object side (front side), and the right side is an image side (rear side). An aperture stop SP determines (limits) a light flux corresponding to a full aperture F-number (Fno). The optical system L0 according to each example includes multiple lenses or optical elements. The optical system L0 according to each example may include a Fresnel lens, a metalens, and a diffraction optical element.

If the optical system according to each example is used in an image pickup apparatus, such as a camera for a portable terminal, a video camera, or a digital camera, an image plane IP corresponds to a solid-state image pickup element (photoelectric conversion element), such as a charge-coupled device (CCD) sensor or a complementary metal oxide semiconductor (CMOS) sensor. If the optical system according to each example is used in an image pickup apparatus such as a silver-halide film camera, the image plane IP corresponds to a film surface.

Reference sign FL denotes an optical block corresponding to, for example, an optical filter, a low-pass filter, or an infrared cut filter.

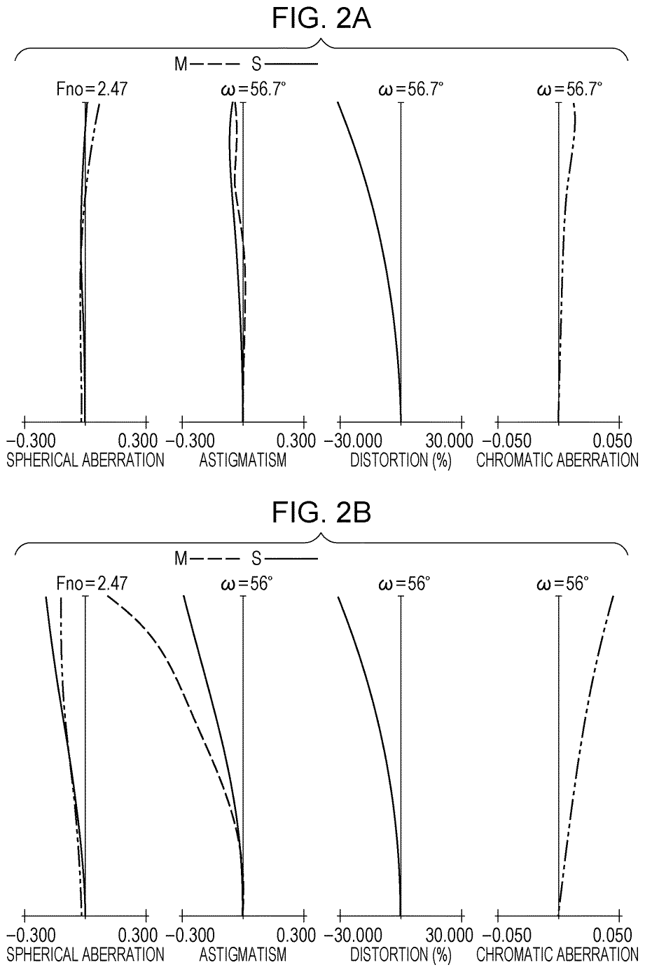

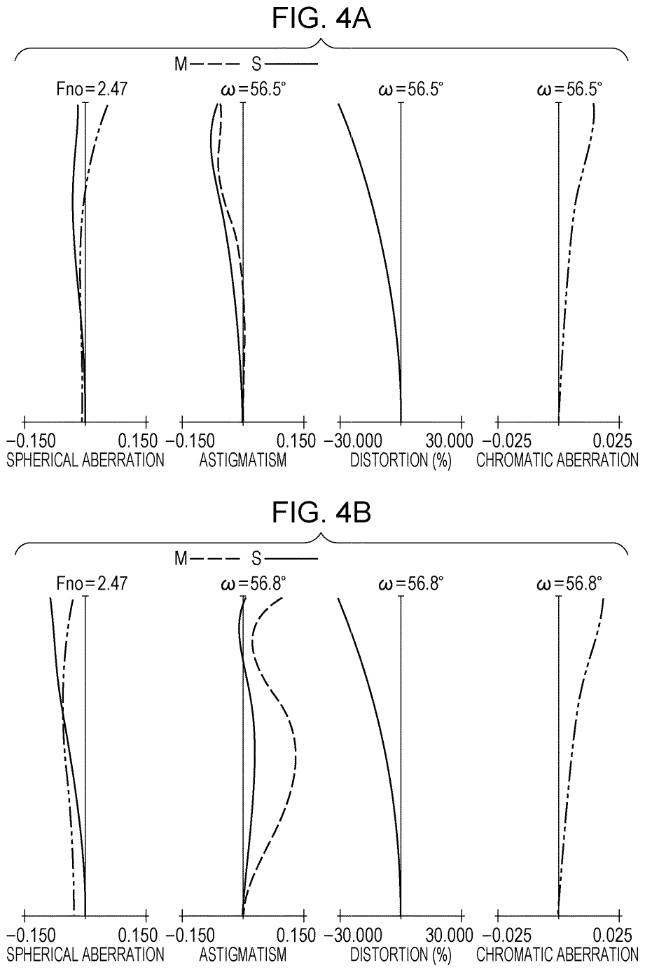

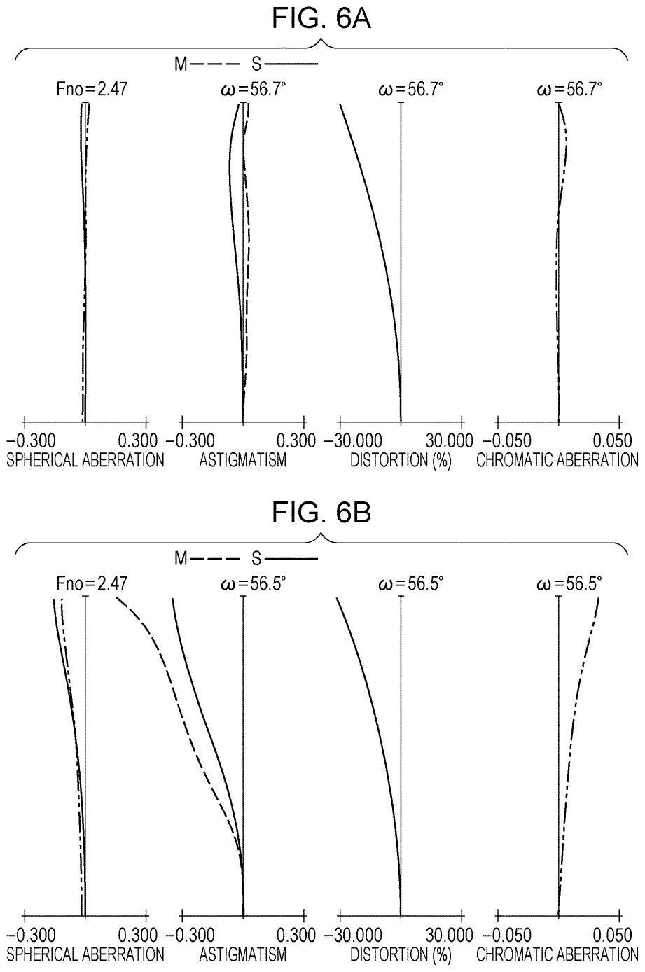

FIGS. 2A, 4A, and 6A are aberration diagrams corresponding to when focusing is performed onto an object at infinity in the optical system L0 according to examples 1 to 3, respectively, and FIGS. 2B, 4B, and 6B are aberration diagrams corresponding to when focusing is performed onto an object at a close distance in the optical system L0 according to examples 1 to 3, respectively.

In each spherical aberration diagram, Fno denotes an F-number, a solid line denotes spherical aberration with respect to the d-line (wavelength of 587.6 nm), and a double-dotted chain line denotes spherical aberration with respect to the g-line (wavelength of 435.8 nm). In each astigmatism diagram, a solid line S denotes a sagittal image plane, and a dashed line M denotes a meridional image plane. In each distortion diagram, a distortion amount with respect to the d-line is shown. In each chromatic aberration diagram, chromatic aberration with respect to the g-line is shown. Moreover, ω denotes a half field angle [°].

The optical system L0 according to a first embodiment will now be described.

The optical system L0 according to the first embodiment includes a front lens unit Lf that is fixed relative to an image plane during focusing, and a focus lens unit Focus that is disposed adjacent to the image side of the front lens unit Lf and that moves during focusing. The distance between adjacent lens units changes during focusing.

A lens unit is a group of lenses that move together or remain fixed relative to an image plane during focusing, and may be constituted of a single lens or multiple lenses.

With the front lens unit Lf being fixed relative to an image plane during focusing, it is possible to suppress an increase in the overall lens length at infinity or at a close distance. The overall lens length is a value obtained by adding back focus to the distance along the optical axis from the surface closest to the object side to the surface closest to the image side in the optical system L0. Back focus is a value obtained by performing air conversion on the distance along the optical axis between the surface closest to the image side of the optical system L0 and the image plane.

Furthermore, the optical system L0 includes an aspherical lens LA disposed at the image side relative to the front lens unit Lf, so that the aspherical lens LA can be disposed in the focus lens unit Focus or at the image side relative to the focus lens unit Focus. As a result, variations in various off-axis aberrations and the like that occur during focusing can be readily suppressed.

The optical system L0 according to the first embodiment satisfies the above configuration, whereby a compact optical system having high optical performance can be provided.

The optical system L0 according to a second embodiment is different from the first embodiment in that at least one surface of the aspherical lens LA has an inflection point. Accordingly, with respect to off-axis light rays, the signs of the refractive power at radially high and low positions of the aspherical lens LA can be varied, thereby readily suppressing variations in field curvature, variations in distortion, and the like that occur during focusing.

An inflection point is where the value of the second derivative of x(h) with respect to h becomes zero, where x denotes the displacement amount from the surface vertex in the optical-axis direction, h denotes the height in a direction (radial direction) perpendicular to the optical axis, and the aspherical shape is expressed as x(h). Moreover, the inflection point is where the sign of the second derivative changes before and after that point. In other words, the inflection point is where the surface shape changes from a concave shape to a convex shape, or from a convex shape to a concave shape.

With the lens surface having such an inflection point, the refractive power in the peripheral region can be determined independently of the refractive power in the paraxial region, thereby facilitating correction of various aberrations occurring at peripheral image heights. The position of the inflection point may be set to any position radially outward from the optical axis so long as the position is located within the effective diameter of the lens.

The optical system L0 according to the second embodiment satisfies the above configuration, whereby a compact optical system having high optical performance can be provided.

An exemplary configuration of the optical system L0 according to examples of each embodiment will now be described.

In one embodiment, the optical system L0 includes the aperture stop SP, and the focus lens unit Focus is disposed at the image side relative to the aperture stop SP. The aspherical lens LA disposed in the focus lens unit Focus or at the image side relative to the focus lens unit Focus facilitates correction for reducing an incident angle of an off-axis light ray onto the image plane. This facilitates suppression of color shading that occurs when an image pickup element is disposed.

In one embodiment, the focus lens unit Focus further includes two or more aspherical lenses. Accordingly, variations in various aberrations and the like that occur during focusing can be readily suppressed.

In one embodiment, at least two lenses disposed in the focus lens unit Focus are bonded at a tapered edge portion (are preferably fitted with each other at the tapered edge portion). This bonding at the tapered section facilitates suppression of eccentricity caused by a manufacturing error.

In one embodiment, the lens surface at the image side of the aspherical lens LA has a concave shape toward the image side on the optical axis and a convex shape toward the image side in a peripheral region. Accordingly, the principal point of the optical system L0 can be readily disposed at the object side, the overall lens length can be readily shortened, and correction can be readily performed for reducing an incident angle of an off-axis light ray onto the image plane.

In one embodiment, the front lens unit Lf includes a first partial unit Lf1, the aperture stop SP, and a second partial unit Lf2 that are arranged sequentially from the object side toward the image side. Accordingly, the height from the optical axis of an off-axis light ray entering each of lenses disposed in the first partial unit Lf1 and the second partial unit Lf2 can be reduced, whereby an increase in the diameter of each lens can be readily suppressed.

In one embodiment, the focus lens unit Focus has positive refractive power. By performing focusing using a lens unit having positive refractive power, the refraction angle of an off-axis light ray can be reduced when performing focusing at a close distance, thereby facilitating reduction of field curvature and the like at close range.

In one embodiment, the following description relates to conditions that are satisfied by the optical system L0 according to examples of each embodiment.

In one embodiment, the optical system L0 according to each example satisfies at least one of inequalities (1) to (5) indicated below.

0.00<Sag/Ea<0.20 (1)

0.01<Bt/Et<1.60 (2)

1.50<Nd<1.70 (3)

0.04<Sg/Et (4)

14.0<vd<40.0 (5)

In this case, among lenses having an inflection point, the aspherical lens LA is disposed closest to the image side in the optical system L0, and the sagittal amount and the effective ray diameter of the lens surface at the image side of the aspherical lens LA are denoted by Sag and Ea, respectively. In this case, the sagittal amount is a difference in the optical-axis direction between the surface vertex and a position P on the lens surface when, in the radial direction, the position P on the lens surface is where an absolute value of the difference in the optical-axis direction relative to the surface vertex is the greatest. The sagittal amount is a positive value when the position P on the lens surface is located at the image side relative to the surface vertex.

The distance along the optical axis from the aperture stop SP disposed in the optical system L0 to the image plane is defined as Bt, and the effective ray diameter of the lens surface closest to the image side in the optical system L0 is defined as Et. The refractive index of the material of the aspherical lens LA with respect to the d-line is defined as Nd.

The total mass of all lenses disposed in the focus lens unit Focus is defined as Sg, and the effective ray diameter of the lens surface closest to the image side in the optical system L0 is defined as Et. In the second partial unit Lf2, the Abbe number of the material of a negative lens disposed closest to the object side is defined as vd.

The technical meaning of each of the inequalities indicated above will now be described.

If Sag/Ea is less than the lower limit of the inequality (1), the sagittal amount becomes a negative value, thus making it difficult to correct various aberrations of an off-axis light ray. When the upper limit of the inequality (1) is exceeded, the sagittal amount becomes too large, thus making it difficult to form a desired shape.

In one embodiment, the lower limit of the inequality (1) is set to any of 0.04, 0.08, and 0.10.

In one embodiment, the upper limit of the inequality (1) is set to any of 0.18, 0.17, and 0.16.

If Bt/Et is less than the lower limit of the inequality (2), the effective ray diameter of the lens surface closest to the image side in the optical system L0 becomes too large. This is not preferable since the optical system L0 increases in size in the radial direction. When the upper limit of the inequality (2) is exceeded, the distance from the aperture stop SP to the image plane increases. This is not preferable since the overall lens length becomes too large.

In one embodiment, the lower limit of the inequality (2) is set to any of 0.40, 0.80, and 1.20.

In one embodiment, the upper limit of the inequality (2) is set to any of 1.58, 1.56, and 1.54.

If Nd is less than the lower limit of the inequality (3), the refractive index of the material of the aspherical lens LA decreases, and the curvature of the aspherical lens LA becomes too large. This is not preferable since the overall lens length increases.

When the upper limit of the inequality (3) is exceeded, the refractive index of the material of the aspherical lens LA increases, and the Abbe number becomes too small for an optical material. This is not preferable since lateral chromatic aberration occurring at the aspherical lens LA becomes too large.

In one embodiment, the lower limit of the inequality (3) is set to any of 1.52, 1.53, and 1.55.

In one embodiment, the upper limit of the inequality (3) is set to any of 1.68, 1.65, and 1.64.

If Sg/Et is less than the lower limit of the inequality (4), the effective ray diameter of the lens surface closest to the image side in the optical system L0 becomes too large. This is not preferable since the optical system L0 increases in size in the radial direction.

In one embodiment, the lower limit of the inequality (4) is set to any of 0.050, 0.055, and 0.060.

In one embodiment, the upper limit of the inequality (4) is set to any of 0.300, 0.200, and 0.100.

When the front lens unit Lf includes the first partial unit Lf1, the aperture stop SP, and the second partial unit Lf2 that are arranged sequentially from the object side toward the image side, the inequality (5) is an inequality related to the Abbe number vd of the material of the negative lens disposed closest to the object side in the second partial unit Lf2.

If vd is less than the lower limit of the inequality (5), the material of the negative lens disposed closest to the object side in the second partial unit Lf2 becomes too highly dispersive. This is not preferable since longitudinal chromatic aberration and lateral chromatic aberration occurring at the negative lens disposed closest to the object side in the second partial unit Lf2 become too large.

When the upper limit of the inequality (5) is exceeded, the material of the negative lens disposed closest to the object side in the second partial unit Lf2 becomes too lowly dispersive. This is not preferable since longitudinal chromatic aberration and lateral chromatic aberration occurring at the front lens unit Lf become insufficiently corrected.

In one embodiment, the lower limit of the inequality (5) is set to any of 18.0, 20.0, and 22.0.

In one embodiment, the upper limit of the inequality (5) is set to any of 38.0, 34.0, and 30.0.

The optical system L0 according to each of examples 1 to 3 will now be described in detail.

In example 1 and 3, the optical system L0 includes the front lens unit Lf that is fixed relative to an image plane during focusing, and the focus lens unit Focus that is disposed adjacent to the image side of the front lens unit Lf and that moves during focusing. The focus lens unit Focus includes two positive lenses and one negative lens, thereby facilitating suppression of variations in lateral chromatic aberration occurring during focusing.

In each of examples 1 to 3, the front lens unit Lf includes the first partial unit Lf1, the aperture stop SP, and the second partial unit Lf2 that are arranged sequentially from the object side toward the image side. With a negative lens disposed closest to the object side in the first partial unit Lf1, the diameter of the front lens is reduced. Furthermore, the second partial unit Lf2 includes a positive lens and a negative lens, thereby favorably correcting longitudinal chromatic aberration and spherical aberration.

In example 2, the optical system L0 includes the front lens unit Lf that is fixed relative to an image plane during focusing, the focus lens unit Focus that is disposed adjacent to the image side of the front lens unit Lf and that moves during focusing, and a rear lens unit that is fixed relative to an image plane during focusing.

The focus lens unit Focus that moves during focusing includes two positive lenses, so that the focus lens unit Focus is reduced in weight. Accordingly, an actuator that drives the focus lens unit Focus can be readily reduced in size, thereby facilitating size reduction of the optical system L0.

The following are numerical examples 1 to 3 respectively corresponding to examples 1 to 3. In each numerical example, a surface number i indicates the number of a surface as counted from the object side, r denotes the curvature radius (mm) of an i-th surface from the object side, d denotes the lens thickness or air distance (mm) along the optical axis between i-th and (i+1)-th surfaces, and nd denotes the refractive index at the d-line of the optical material between the i-th surface and the (i+1)-th surface. The sign of d is defined such that the direction from the object side toward the image side is positive along the optical axis. vd denotes the Abbe number, based on the d-line, of the optical material between the i-th surface and the (i+1)-th surface. An effective diameter is the effective ray diameter of each surface.

BF denotes the distance (mm) along the optical axis from the surface closest to the image side to the image plane. The overall lens length denotes the distance along the optical axis from the lens surface (front-most surface) closest to the object side of the optical system L0 to the image plane.

A flat plate disposed closest to the image side in each example is a glass block and corresponds to a low-pass filter or a cut filter. The flat plate is not included in the lenses described in this description.

A sign * is given to the right of a surface number when an optical surface is aspherical. An aspherical shape is defined such that X denotes a displacement amount from the surface vertex in the optical-axis direction, h denotes a height from the optical axis in a direction perpendicular to the optical axis, R denotes a paraxial curvature radius, k denotes a conic constant, and A4, A6, A8, A10, and A12 denote aspherical coefficients of respective orders. In this case, the following expression is used.

X=(h²/R)/[1+{1−(1+k)(h/R)²}]^{1/2}+A4×h⁴+A6×h⁶+A8×h⁸+A10×h¹⁰+A12×h¹²

In each aspherical coefficient, “e±XX” denotes “×10±^{XX}”

Numerical Example 1
Unit: mm
Surface Data

| Surface | | | | | Effective |
|---|---|---|---|---|---|
| Number | r | d | nd | νd | Diameter |
| 1 | 16.585 | 0.60 | 1.69680 | 55.5 | 13.58 |
| 2 | 5.539 | 3.75 | 9.67 | | |
| 3 | −84.052 | 0.50 | 1.48749 | 70.2 | 8.63 |
| 4 | 17.185 | 1.30 | 7.85 | | |
| 5 | 11.690 | 1.53 | 1.80518 | 25.4 | 6.69 |
| 6 | −47.750 | 0.37 | 5.97 | | |
| 7 (Stop) | ∞ | 2.30 | 5.15 | | |
| 8 | −15.802 | 0.40 | 1.80809 | 22.8 | 6.30 |
| 9 | 6.761 | 2.61 | 1.85135 | 40.1 | 6.60 |
| 10* | −10.811 | −0.15 | 6.60 | | |
| 11 | ∞ (Variable) | 6.33 | | | |
| 12* | 42.109 | 2.80 | 1.53500 | 56.0 | 11.93 |
| 13* | −184.296 | 1.02 | 12.11 | | |
| 14* | 16.084 | 2.60 | 1.53500 | 56.0 | 12.60 |
| 15* | −14.006 | 1.76 | 13.06 | | |
| 16* | −149.887 | 1.40 | 1.63560 | 23.9 | 13.79 |
| 17* | 10.422 (Variable) | 15.87 | | | |
| 18 | ∞ | 0.37 | 1.52300 | 54.5 | 17.28 |
| 19 | ∞ | 0.82 | 25.00 | | |
| 20 | ∞ | 0.50 | 1.51633 | 64.1 | 25.00 |
| 21 | ∞ | 0.78 | 25.00 | | |
| Image Plane | ∞ | | | | |

Aspherical Data
Tenth Surface
K = 0.00000e+00 A4 = 3.71162e−04 A6 = −8.14891e−07 A8 = 5.11121e−07
A10 = −4.16835e−08 A12 = 8.15888e−10
Twelfth Surface
K = 0.00000e+00 A4 = 5.77574e−04
Thirteenth Surface
K = 0.00000e+00 A4 = −6.08600e−04 A6 = 2.66709e−05 A8 = −2.36928e−07
Fourteenth Surface
K = 0.00000e+00 A4 = −7.11681e−04 A6 = 2.25955e−06
Fifteenth Surface
K = 0.00000e+00 A4 = 1.11578e−03 A6 = −4.82884e−05 A8 = 9.34109e−07
A10 = −5.00585e−09
Sixteenth Surface
K = 0.00000e+00 A4 = −5.68152e−04 A6 = −1.92951e−05 A8 = 8.35490e−07
A10 = −8.34308e−09
Seventeenth Surface
K = 0.00000e+00 A4 = −1.69343e−03 A6 = 2.34614e−05 A8 = −1.71216e−07

Various Data

| | |
|---|---|
| Focal Length | 8.21 |
| F-Number | 2.47 |
| Angle of View | 46.48 |
| Image Height | 8.64 |
| Overall Lens Length | 31.21 |
| BF | 0.78 |

Distance between Lens Units during Focusing

| Distance from First | | |
|---|---|---|
| Surface to Object | Infinity | −50 mm |
| d11 | 3.51 | 1.87 |
| d17 | 2.45 | 4.09 |

Lens Unit Data

| Unit | Starting Surface | Focal Length |
|---|---|---|
| 1 | 1 | 1115.12 |
| 2 | 7 | 25.05 |
| 3 | 12 | 26.97 |

Single Lens Data

| Lens | Starting Surface | Focal Length |
|---|---|---|
| 1 | 1 | −12.21 |
| 2 | 3 | −29.22 |
| 3 | 5 | 11.80 |
| 4 | 8 | −5.81 |
| 5 | 9 | 5.24 |
| 6 | 12 | 64.35 |
| 7 | 14 | 14.43 |
| 8 | 16 | −15.28 |
| 9 | 18 | 0.00 |
| 10 | 20 | 0.00 |

Numerical Example 2
Unit: mm
Surface Data

| Surface | | | | | Effective |
|---|---|---|---|---|---|
| Number | r | d | nd | νd | Diameter |
| 1 | 17.012 | 0.60 | 1.69680 | 55.5 | 13.52 |
| 2 | 5.561 | 3.75 | 9.64 | | |
| 3 | −83.447 | 0.50 | 1.48749 | 70.2 | 8.55 |
| 4 | 18.074 | 1.30 | 7.79 | | |
| 5 | 11.758 | 1.53 | 1.80518 | 25.4 | 6.60 |
| 6 | −48.002 | 0.35 | 5.88 | | |
| 7 (Stop) | ∞ | 2.30 | 5.17 | | |
| 8 | −15.672 | 0.40 | 1.80809 | 22.8 | 6.30 |
| 9 | 6.717 | 2.61 | 1.85135 | 40.1 | 6.60 |
| 10* | −10.811 | −0.15 | 6.60 | | |
| 11 | ∞ (Variable) | 6.30 | | | |
| 12* | 44.298 | 2.80 | 1.53500 | 56.0 | 11.61 |
| 13* | −144.097 | 1.02 | 11.88 | | |
| 14* | 16.542 | 2.60 | 1.53500 | 56.0 | 12.43 |
| 15* | −13.751 (Variable) | | 12.93 | | |
| 16* | −165.377 | 1.40 | 1.63560 | 23.9 | 13.67 |
| 17* | 10.387 | 2.57 | 15.71 | | |
| 18 | ∞ | 0.37 | 1.52300 | 54.5 | 18.08 |
| 19 | ∞ | 0.82 | 25.00 | | |
| 20 | ∞ | 0.50 | 1.51633 | 64.1 | 25.00 |
| 21 | ∞ | 0.78 | 25.00 | | |
| Image Plane | ∞ | | | | |

Aspherical Data
Tenth Surface
K = 0.00000e+00 A4 = 3.71162e−04 A6 = −8.14891e−07 A8 = 5.11121e−07
A10 = −4.16835e−08 A12 = 8.15888e−10
Twelfth Surface
K = 0.00000e+00 A4 = 5.77574e−04
Thirteenth Surface
K = 0.00000e+00 A4 = −6.08600e−04 A6 = 2.66709e−05 A8 = −2.36928e−07
Fourteenth Surface
K = 0.00000e+00 A4 = −7.11681e−04 A6 = 2.25955e−06
Fifteenth Surface
K = 0.00000e+00 A4 = 1.11578e−03 A6 = −4.82884e−05 A8 = 9.34109e−07
A10 = −5.00585e−09
Sixteenth Surface
K = 0.00000e+00 A4 = −5.68152e−04 A6 = −1.92951e−05 A8 = 8.35490e−07
A10 = −8.34308e−09
Seventeenth Surface
K = 0.00000e+00 A4 = −1.69343e−03 A6 = 2.34614e−05 A8 = −1.71216e−07

Various Data

| | |
|---|---|
| Focal Length | 8.23 |
| F-Number | 2.47 |
| Angle of View | 46.26 |
| Image Height | 8.60 |
| Overall Lens Length | 31.16 |
| BF | 0.78 |

Distance between Lens Units during Focusing

| Distance from First | | |
|---|---|---|
| Surface to Object | Infinity | −100 mm |
| d11 | 3.39 | 2.96 |
| d15 | 1.72 | 2.15 |

Lens Unit Data

| Unit | Starting Surface | Focal Length |
|---|---|---|
| 1 | 1 | 724.68 |
| 2 | 7 | 25.26 |
| 3 | 12 | 12.32 |
| 4 | 16 | −15.33 |

Single Lens Data

| Lens | Starting Surface | Focal Length |
|---|---|---|
| 1 | 1 | −12.12 |
| 2 | 3 | −30.43 |
| 3 | 5 | 11.87 |
| 4 | 8 | −5.77 |
| 5 | 9 | 5.22 |
| 6 | 12 | 63.66 |
| 7 | 14 | 14.47 |
| 8 | 16 | −15.33 |
| 9 | 18 | 0.00 |
| 10 | 20 | 0.00 |

Numerical Example 3
Unit: mm
Surface Data

| Surface | | | | | Effective |
|---|---|---|---|---|---|
| Number | r | d | nd | νd | Diameter |
| 1 | 20.130 | 0.60 | 1.59522 | 67.7 | 13.40 |
| 2 | 5.305 | 3.98 | 9.50 | | |
| 3 | −568.320 | 0.50 | 1.49700 | 81.5 | 8.11 |
| 4 | 8.594 | 0.56 | 7.20 | | |
| 5 | 8.657 | 2.08 | 1.73800 | 32.3 | 6.90 |
| 6 | −37.793 | 0.30 | 6.00 | | |
| 7 (Stop) | ∞ | 2.20 | 5.05 | | |
| 8 | −18.804 | 0.40 | 1.80809 | 22.8 | 6.00 |
| 9 | 7.126 | 2.39 | 1.85135 | 40.1 | 6.00 |
| 10* | −10.907 | −0.15 | 5.90 | | |
| 11 | ∞ (Variable) | 5.97 | | | |
| 12* | 38.881 | 2.80 | 1.53500 | 56.0 | 11.70 |
| 13* | 47.424 | 0.67 | 12.10 | | |
| 14* | 11.290 | 2.60 | 1.53500 | 56.0 | 12.30 |
| 15* | −16.279 | 1.85 | 12.90 | | |
| 16* | 2548.993 | 1.40 | 1.63560 | 23.9 | 13.50 |
| 17* | 11.459 (Variable) | 15.10 | | | |
| 18 | ∞ | 0.37 | 1.52300 | 54.5 | 18.40 |
| 19 | ∞ | 0.82 | 25.00 | | |
| 20 | ∞ | 0.50 | 1.51633 | 64.1 | 25.00 |
| 21 | ∞ | 0.78 | 25.00 | | |
| Image Plane | ∞ | | | | |

Aspherical Data
Tenth Surface
K = 0.00000e+00 A4 = 3.07676e−04 A6 = −3.53936e−07 A8 = −6.59985e−07
A10 = 1.21593e−07 A12 = −4.93398e−09
Twelfth Surface
K = 0.00000e+00 A4 = 3.94286e−04
Thirteenth Surface
K = 0.00000e+00 A4 = −9.36166e−04 A6 = 2.03589e−05 A8 = −1.99004e−07
Fourteenth Surface
K = 0.00000e+00 A4 = −5.19824e−04 A6 = −1.01154e−05
Fifteenth Surface
K = 0.00000e+00 A4 = 1.63460e−03 A6 = −6.87266e−05 A8 = 1.18288e−06
A10 = −6.47339e−09
Sixteenth Surface
K = 0.00000e+00 A4 = −5.59604e−04 A6 = −2.52054e−05 A8 = 1.09408e−06
A10 = −1.14719e−08
Seventeenth Surface
K = 0.00000e+00 A4 = −1.65142e−03 A6 = 2.67620e−05 A8 = −2.09447e−07

Various Data

| | |
|---|---|
| Focal Length | 8.21 |
| F-Number | 2.47 |
| Angle of View | 47.08 |
| Image Height | 8.83 |
| Overall Lens Length | 31.21 |
| BF | 0.78 |

Distance between Lens Units during Focusing

| Distance from First | | |
|---|---|---|
| Surface to Object | Infinity | −50 mm |
| d11 | 4.19 | 2.58 |
| d17 | 2.35 | 3.97 |

Lens Unit Data

| Unit | Starting Surface | Focal Length |
|---|---|---|
| 1 | 1 | −107.31 |
| 2 | 7 | 21.90 |
| 3 | 12 | 24.59 |

Single Lens Data

| Lens | Starting Surface | Focal Length |
|---|---|---|
| 1 | 1 | −12.29 |
| 2 | 3 | −17.03 |
| 3 | 5 | 9.73 |
| 4 | 8 | −6.35 |
| 5 | 9 | 5.39 |
| 6 | 12 | 362.10 |
| 7 | 14 | 12.88 |
| 8 | 16 | −18.11 |
| 9 | 18 | 0.00 |
| 10 | 20 | 0.00 |

Table 1 indicates numerical values of the physical quantities mentioned above in each example.

TABLE 1

| Inequality | Example 1 | Example 2 | Example 3 |
|---|---|---|---|
| (1) Sag/Ea | 0.121 | 0.158 | 0.125 |
| (2) Bt/Et | 1.459 | 1.473 | 1.535 |
| (3) Nd | 1.636 | 1.636 | 1.636 |
| (4) Sg/Et | 0.070 | 0.069 | 0.067 |
| (5) νd | 23.900 | 23.900 | 23.900 |
| Parameter | Example 1 | Example 2 | Example 3 |
| Sag | 1.923 | 2.042 | 1.892 |
| Ea | 15.871 | 12.927 | 15.100 |
| Bt | 23.160 | 23.138 | 23.185 |
| Et | 15.871 | 15.711 | 15.100 |
| νd | 23.900 | 23.900 | 23.900 |
| nd | 1.636 | 1.636 | 1.636 |
| Sg | 1.113 | 1.087 | 1.017 |

### Image Pickup Apparatus

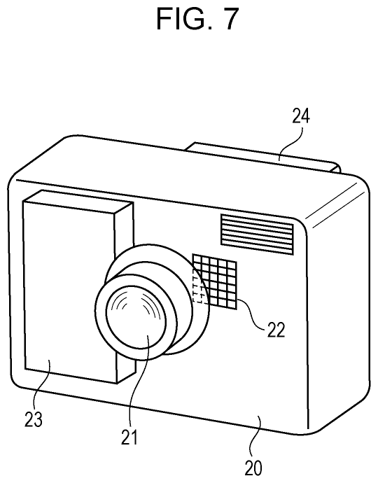

An example of an image pickup apparatus using the optical system L0 according to each example as an image pickup optical system will now be described with reference to FIG. 7. In FIG. 7, a camera body 20 includes an image pickup optical system 21 similar to the optical system L0 described in any of examples 1 to 3, and a solid-state image pickup element (photoelectric conversion element) 22 that is contained within the camera body 20 and that optically receives a subject image formed by the image pickup optical system 21.

The solid-state image pickup element 22 is, for example, a CCD sensor or a CMOS sensor. A memory 23 is a recorder that records the subject image optically received by the image pickup element 22. A viewfinder 24 is used for observing the subject image formed on the image pickup element 22 and displayed on a display element (not illustrated).

The camera body 20 may be a single-lens reflex camera having a quick-return mirror, may be a mirrorless camera reflex camera not having a quick-return mirror, or may be incorporated in a portable terminal including a smartphone.

By applying the optical system L0 according to each example to an image pickup apparatus, such as a digital still camera, in this manner, a compact high-optical-performance image pickup optical system and an image pickup apparatus equipped with the same can be obtained.

Although embodiments and examples disclosed in this description have been described above, the disclosure in this description is not limited to these embodiments and examples, and various combinations, modifications, and alterations are possible within the scope of the disclosure.

In the optical system L0 according to each example, the lenses included therein may be entirely or partially used as a vibration control lens unit, or the optical system L0 may have an image stabilization function by moving the image pickup surface in a direction parallel to the optical axis.

In the optical system L0 according to each example, the lenses included therein may be entirely or partially used as a lens or lenses for focusing. Moreover, the optical system L0 may have a diffractive optical element in addition to a refractive optical element.

The disclosure of the embodiments includes the following configurations.

### Configuration 1

An optical system includes: a front lens unit that is fixed relative to an image plane during focusing; and a focus lens unit that is disposed adjacent to an image side of the front lens unit and that moves during focusing. A distance between adjacent lens units changes during focusing. The focus lens unit includes an aspherical lens. At least one surface of the aspherical lens has an inflection point.

### Configuration 2

In the optical system according to configuration 1, the aspherical lens is a lens having the inflection point and disposed closest to the image side in the optical system, and satisfies an inequality indicated below:

0.00<Sag/Ea<0.20

where Sag denotes a sagittal amount of a lens surface at the image side of the aspherical lens, and Ea denotes an effective ray diameter of the lens surface at the image side of the aspherical lens.

### Configuration 3

In the optical system according to configuration 1 or 2, the optical system includes an aperture stop, and the focus lens unit is disposed at the image side relative to the aperture stop.

### Configuration 4

In the optical system according to configuration 1, the focus lens unit includes a plurality of aspherical lenses.

### Configuration 5

In the optical system according to any one of configurations 1 to 3, the optical system includes an aperture stop and satisfies an inequality indicated below:

0.01<Bt/Et<1.60

where Bt denotes a distance along an optical axis from the aperture stop to an image plane, and Et denotes an effective ray diameter of a lens surface closest to the image side in the optical system.

### Configuration 6

In the optical system according to any one of configurations 1 to 5, an inequality indicated below is satisfied:

1.50<Nd<1.70

where Nd denotes a refractive index with respect to a d-line of a material of the aspherical lens.

### Configuration 7

In the optical system according to any one of configurations 1 to 6, an inequality indicated below is satisfied:

0.04<Sg/Et

where Sg denotes a total mass of all lenses disposed in the focus lens unit, and Et denotes an effective ray diameter of a lens surface closest to the image side in the optical system.

### Configuration 8

In the optical system according to any one of configurations 1 to 7, at least two lenses disposed in the focus lens unit are bonded at a tapered edge portion.

### Configuration 9

In the optical system according to any one of configurations 1 to 8, a lens surface at the image side of the aspherical lens has a concave shape toward the image side on an optical axis and a convex shape toward the image side in a peripheral region.

### Configuration 10

In the optical system according to any one of configurations 1 to 9, the front lens unit includes a first partial unit, an aperture stop, and a second partial unit that are arranged sequentially from an object side toward the image side.

### Configuration 11

In the optical system according to configuration 10, an inequality indicated below is satisfied:

14.0<vd<40.0

where vd denotes an Abbe number of a material of a negative lens disposed closest to the object side in the second partial unit.

### Configuration 12

In the optical system according to any one of configurations 1 to 11, the focus lens unit has positive refractive power.

### Configuration 13

In the optical system according to any one of configurations 1 to 12, the front lens unit and the focus lens unit are arranged sequentially from an object side toward the image side.

### Configuration 14

The optical system according to any one of configurations 1 to 13 further includes a rear lens unit that is fixed relative to an image plane during focusing. The front lens unit, the focus lens unit, and the rear lens unit are arranged sequentially from an object side toward the image side.

### Configuration 15

An optical system includes: a front lens unit that is fixed relative to an image plane during focusing; and a focus lens unit that is disposed adjacent to an image side of the front lens unit and that moves during focusing, wherein a distance between adjacent lens units changes during focusing, and wherein the focus lens unit includes an aspherical lens.

### Configuration 16

An image pickup apparatus includes: the optical system according to any one of configurations 1 to 15; and an image pickup element that optically receives an image formed by the optical system.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-078494, filed May 9, 2025, which is hereby incorporated by reference herein in its entirety.

What is claimed is:

1. An optical system comprising:
a front lens unit that is fixed relative to an image plane during focusing; and
a focus lens unit that is disposed adjacent to an image side of the front lens unit and that moves during focusing,
wherein a distance between adjacent lens units changes during focusing,
wherein the optical system includes an aspherical lens A disposed at the image side relative to the front lens unit, and
wherein at least one lens surface of the aspherical lens A has an inflection point.

2. The optical system according to claim 1, further comprising:
one or more aspherical lenses,
wherein among the aspherical lenses, the aspherical lens A is a lens having the inflection point and disposed closest to the image side in the optical system, and
wherein the following inequality is satisfied:
0.00<Sag/Ea<0.20
where Sag denotes a sagittal amount of a lens surface at the image side of the aspherical lens A, and Ea denotes an effective ray diameter of the lens surface at the image side of the aspherical lens A.

3. The optical system according to claim 1,
wherein the optical system includes an aperture stop, and the focus lens unit is disposed at the image side relative to the aperture stop.

4. The optical system according to claim 1,
wherein the focus lens unit includes a plurality of aspherical lenses including the aspherical lens A.

5. The optical system according to claim 1,
wherein the optical system includes an aperture stop, and
wherein the following inequality is satisfied:
0.01<Bt/Et<1.60
where Bt denotes a distance along an optical axis from the aperture stop to an image plane, and Et denotes an effective ray diameter of a lens surface closest to the image side in the optical system.

6. The optical system according to claim 1,
wherein the following inequality is satisfied:
1.50<Nd<1.70
where Nd denotes a refractive index with respect to a d-line of a material of the aspherical lens A.

7. The optical system according to claim 1,
wherein the following inequality is satisfied:
0.04<Sg/Et
where Sg denotes a total mass of all lenses disposed in the focus lens unit, and Et denotes an effective ray diameter of a lens surface closest to the image side in the optical system.

8. The optical system according to claim 1,
wherein at least two lenses disposed in the focus lens unit are fitted at a tapered edge portion.

9. The optical system according to claim 1,
wherein a lens surface at the image side of the aspherical lens A has a concave shape toward the image side on an optical axis and a convex shape toward the image side in a peripheral region.

10. The optical system according to claim 1,
wherein the front lens unit includes a first partial unit, an aperture stop, and a second partial unit that are arranged sequentially from an object side toward the image side.

11. The optical system according to claim 10,
wherein the following inequality is satisfied:
14.0<vd<40.0
where vd denotes an Abbe number of a material of a negative lens disposed closest to the object side in the second partial unit.

12. The optical system according to claim 1,
wherein the focus lens unit has positive refractive power.

13. The optical system according to claim 1,
wherein the front lens unit and the focus lens unit are arranged sequentially from an object side toward the image side.

14. The optical system according to claim 1, further comprising:
a rear lens unit that is fixed relative to an image plane during focusing,
wherein the front lens unit, the focus lens unit, and the rear lens unit are arranged sequentially from an object side toward the image side.

15. An apparatus comprising:
an optical system; and
an element that optically receives an image formed by the optical system,
wherein the optical system includes:
a front lens unit that is fixed relative to an image plane during focusing; and
a focus lens unit that is disposed adjacent to an image side of the front lens unit and that moves during focusing,
wherein a distance between adjacent lens units changes during focusing,
wherein the optical system includes an aspherical lens A disposed at the image side relative to the front lens unit, and
wherein at least one surface of the aspherical lens A has an inflection point.

16. The apparatus according to claim 15, wherein the optical system further comprises:
one or more aspherical lenses,
wherein among the aspherical lenses, the aspherical lens A is a lens having the inflection point and disposed closest to the image side in the optical system, and
wherein the following inequality is satisfied:
0.00<Sag/Ea<0.20
where Sag denotes a sagittal amount of a lens surface at the image side of the aspherical lens A, and Ea denotes an effective ray diameter of the lens surface at the image side of the aspherical lens A.

17. The apparatus according to claim 15,
wherein the optical system includes an aperture stop, and the focus lens unit is disposed at the image side relative to the aperture stop.

18. The apparatus according to claim 15,
wherein the focus lens unit includes a plurality of aspherical lenses including the aspherical lens A.

19. The apparatus according to claim 15,
wherein the optical system includes an aperture stop, and
wherein the following inequality is satisfied:
0.01<Bt/Et<1.60
where Bt denotes a distance along an optical axis from the aperture stop to an image plane, and Et denotes an effective ray diameter of a lens surface closest to the image side in the optical system.

20. The apparatus according to claim 15,
wherein, in the optical system, the following inequality is satisfied:
1.50<Nd<1.70
where Nd denotes a refractive index with respect to a d-line of a material of the aspherical lens A.
